(19) United States
(12) Patent Application Publication
(10) Pub. No.: US 2026/0174022 A1
(43) Pub. Date: Jun. 25, 2026

(54) METHODS, SYSTEMS, AND STORAGE MEDIA FOR EMERGENCY SUPERVISION OF TAILINGS PONDS BASED ON LARGE MODELS OF INTERNET OF THINGS (IOT)

(71) Applicant: CHENGDU QINCHUAN IOT TECHNOLOGY CO., LTD., Chengdu (CN)

(72) Inventors: Hanshu SHAO, Chengdu (CN); Yong LI, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 19/536,175

(22) Filed: Feb. 10, 2026

(30) Foreign Application Priority Data
Jan. 15, 2026 (CN) 202610052639.7

(51) Int. Cl. A01G 25/16; C02F 1/00; G06F 16/29; G06N 20/00

(52) U.S. Cl. CPC A01G 25/16; A01G 25/167; C02F 1/004; G06F 16/29; G06N 20/00

(57) ABSTRACT

A system, a method, and a storage medium for emergency supervision of a tailings pond based on a large model of Internet of Things (IOT) are provided. The system includes an emergency supervision management platform configured to: determine a plurality of local strain data of the tailings pond; determine a rainfall response capacity of the tailings pond based on water level information obtained by a sensor disposed at the tailings pond; determine tailings stability data at a current time point and a future time point based on the plurality of local strain data; determine a target time point and a discharge parameter corresponding to the target time point based on the rainfall response capacity and the tailings stability data; and control a plurality of drainage wells to open drainage valves to perform drainage at the target time point based on the discharge parameter.

### CROSS-REFERENCE TO RELATED APPLICATIONS

This application claims priority to Chinese Patent Application No. 202610052639.7, filed on Jan. 15, 2026, the entire contents of which are hereby incorporated by reference.

### TECHNICAL FIELD

The present disclosure relates to a field of emergency supervision of a tailings pond, and in particular to a system, a method, and a storage medium for emergency supervision of a tailings pond based on a large model of Internet of Things (IOT).

### BACKGROUND

A tailings pond is a man-made facility designed for the storage of tailings or other industrial waste residues discharged after ore processing in metal or non-metal mines. Due to factors such as heavy rainfall, a large volume of water with high potential energy may accumulate in the tailings pond, posing risks such as overtopping, dam failure, cracks in the dam body, landslides in the dam body, and seepage damage. Additionally, excessively rapid drainage may cause damage to drainage wells or exacerbate risks such as tailings collapse, thereby endangering the safety of residents in downstream urban areas.

Therefore, it is desirable to provide a system, a method, and a storage medium for emergency supervision of a tailings pond based on a large model of IoT, which can supervise the tailings pond, thereby avoiding accidents as much as possible and ensuring the safety of downstream urban residents.

### SUMMARY

One or more embodiments of the present disclosure provide a system for emergency supervision of a tailings pond based on a large model of Internet of Things (IOT), comprising: an emergency supervision management platform. The emergency supervision management platform is configured to: determine a plurality of local strain data of the tailings pond based on optical fiber signals obtained from segments of a distributed optical fiber disposed at a plurality of geographical locations of the tailings pond, and a spatial resolution of the distributed optical fiber; determine a rainfall response capacity of the tailings pond based on water level information obtained by a sensor disposed in the tailings pond; determine tailings stability data at a current time point and a future time point, respectively, based on the plurality of local strain data; determine a target time point and a discharge parameter corresponding to the target time point based on the rainfall response capacity and the tailings stability data; and control a plurality of drainage wells to open drainage valves of the plurality of drainage wells to perform drainage at the target time point based on the discharge parameter.

One or more embodiments of the present disclosure provide a method for emergency supervision of a tailings pond, implemented by an emergency supervision management platform of a system for emergency supervision of the tailings pond based on a large model of Internet of Things (IOT). The method comprises: determining a plurality of local strain data of the tailings pond based on optical fiber signals obtained from segments of a distributed optical fiber disposed at a plurality of geographical locations of the tailings pond, and a spatial resolution of the distributed optical fiber; determining a rainfall response capacity of the tailings pond based on water level information obtained by a sensor disposed in the tailings pond; determining tailings stability data at a current time point and a future time point, respectively, based on the plurality of local strain data; determining a target time point and a discharge parameter corresponding to the target time point based on the rainfall response capacity and the tailings stability data; and controlling a plurality of drainage wells to open drainage valves of the plurality of drainage wells to perform drainage at the target time point based on the discharge parameter.

One or more embodiments of the present disclosure provide a non-transitory computer-readable storage medium. The storage medium stores computer instructions, wherein when a computer reads the computer instructions in the storage medium, the computer executes a method for emergency supervision of a tailings pond.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of a platform structure of a system for emergency supervision of a tailings pond based on a large model of IoT according to some embodiments of the present disclosure.

FIG. 2 is a flowchart of an exemplary process of a method for emergency supervision of a tailings pond based on a large model of IoT according to some embodiments of the present disclosure.

FIG. 3 is a flowchart of an exemplary process for determining tailings stability data according to some embodiments of the present disclosure.

FIG. 4 is an exemplary schematic diagram of a tailings analysis model according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships can exist, e.g., A and/or B, which may be represented as: A alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Furthermore, if the description of the embodiments in the present disclosure involves descriptions such as “first” and “second,” then these descriptions are for descriptive purposes only and are not to be construed as indicating or implying relative importance or implicitly specifying the quantity of the indicated technical features. Thus, features defined by “first” or “second” may explicitly or implicitly include at least one such feature.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

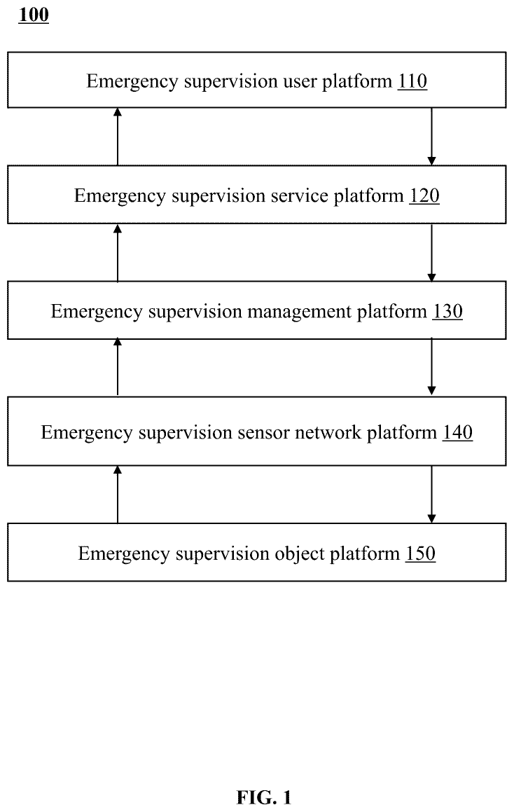

FIG. 1 is a schematic diagram of a platform structure of a system for emergency supervision of a tailings pond based on a large model of IoT according to some embodiments of the present disclosure.

In some embodiments, as shown in FIG. 1, a system 100 for emergency supervision of a tailings pond based on a large model of IoT (also referred to as the system 100 or the emergency supervision system 100) includes an emergency supervision user platform 110, an emergency supervision service platform 120, an emergency supervision management platform 130, an emergency supervision sensor network platform 140, and an emergency supervision object platform 150.

In some embodiments, one or more platforms in the system 100 exchange information and/or data through a network.

The emergency supervision user platform 110 refers to a platform for a supervision user to supervise the operation of the system 100. The supervision user includes personnel from a safety management department, etc. The emergency supervision user platform includes at least one personnel interaction device, for example, a mobile phone, a computer, etc.

The emergency supervision service platform 120 refers to a platform for receiving and transmitting data and/or information. The emergency supervision service platform 120 is configured as a server or a processor. The emergency supervision service platform 120 may perform bidirectional data interaction with the emergency supervision user platform 110 and the emergency supervision management platform 130.

The emergency supervision management platform 130 is a comprehensive management platform for managing and coordinating connections and collaborations among multiple platforms. The emergency supervision management platform is configured as a server or a processor. The emergency supervision management platform 130 is communicatively connected to the emergency supervision object platform 150 through the emergency supervision sensor network platform 140.

The emergency supervision sensor network platform 140 is configured to comprehensively manage sensor information, and is a communication transmission platform that enables bidirectional data interaction between the emergency supervision management platform 130 and the emergency supervision object platform 150. The emergency supervision sensor network platform 140 may be configured as a communication network, a gateway, or the like. The emergency supervision sensor network platform 140 is responsible for uploading real-time sensor data collected by the emergency supervision object platform 150 to the emergency supervision management platform 130, and delivering control instructions generated in the emergency supervision management platform 130 to the corresponding emergency supervision object platform 150 for execution.

The emergency supervision object platform 150 is a platform for generating supervision information and executing control information. The emergency supervision object platform 150 includes a plurality of monitoring, sensing, and interaction devices, such as drainage facilities, sensors (e.g., water level sensors, piezometric sensors, etc.), alarm devices, etc.

A drainage facility is a device for drainage. In some embodiments, the drainage facilities include a plurality of drainage wells and valves of the drainage wells, etc. The count and locations of the drainage wells are set in advance according to actual needs.

A water level sensor refers to a device arranged in the tailings pond for monitoring a water level of the tailings pond. The water level sensor includes a float ball water level sensor, an ultrasonic water level sensor, a laser water level sensor, etc.

A piezometric sensor is a device for measuring a phreatic line and a water content.

In some embodiments, deployment positions, depths/heights, quantities, and density of sensors in the tailings pond are predetermined based on actual requirements.

An alarm device is a device for issuing an early warning in an abnormal situation. The count and locations of the alarm devices are set in advance based on actual requirements.

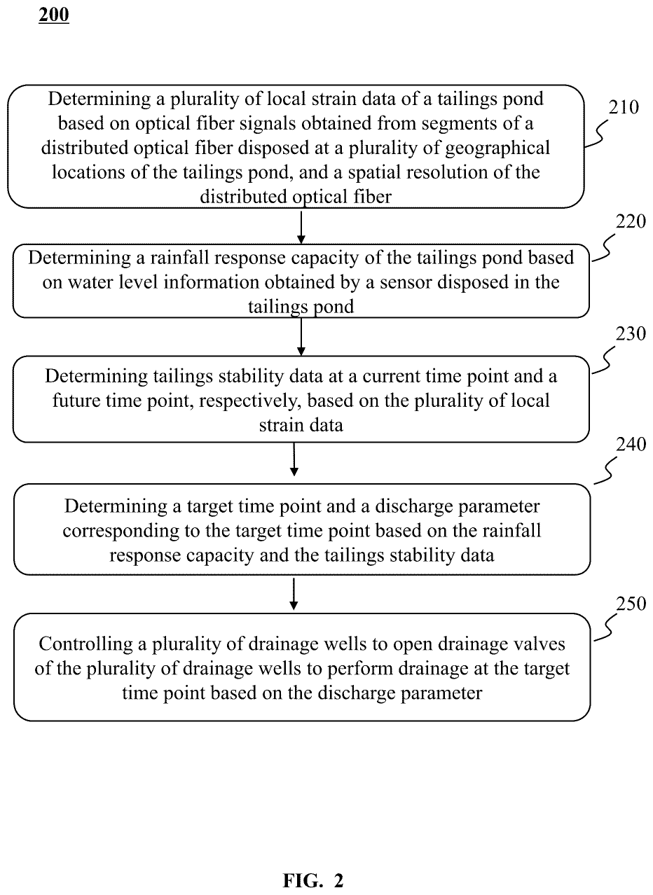

For more content regarding the above, reference may be made to FIG. 2 to FIG. 4.

Through the system 100, communication connections can be established among the various platforms, forming closed-loop information operation between functional platforms. Under the unified management of the emergency supervision management platform, these platforms operate in a coordinated and regulated manner, achieving information-based and smart emergency supervision of tailings ponds.

FIG. 2 is a flowchart of an exemplary process of a method for emergency supervision of a tailings pond based on a large model of IoT according to some embodiments of the present disclosure. Process 200 is performed by an emergency supervision management platform (e.g., the emergency supervision management platform 130).

In 210, determining a plurality of local strain data of the tailings pond based on optical fiber signals obtained from segments of a distributed optical fiber disposed at a plurality of geographical locations of the tailings pond, and a spatial resolution of the distributed optical fiber.

Tailings refer to waste materials remaining after ore is crushed and useful components are extracted through mineral processing. The tailings pond refers to a facility formed by constructing dams to block valleys or enclose areas, used for storing tailings or other industrial waste residues discharged after ore beneficiation in metal or non-metal mines.

The plurality of geographical locations of the tailings pond refers to a plurality of positions where the segments of the optical fiber are distributed in the tailings pond.

The distribution of the segments of the optical fiber in the tailings pond (at the plurality of geographical locations) is set in advance by technical personnel based on prior experience.

The optical signals refer to the laser pulses emitted into the optical fiber by a transmitter and the backscattered light subsequently received by a receiver. When tailings displacement causes vibration or strain on a segment of the fiber, the properties of the backscattered light from the segment received by the transmitter change accordingly.

In some embodiments, the emergency supervision management platform directly collects and obtains the optical fiber signals through the distributed optical fiber.

The spatial resolution refers to data reflecting monitoring accuracy and acquisition density of the distributed optical fiber. In some embodiments, the spatial resolution may be determined based on a deployment density of the distributed optical fiber (i.e., the deployment density of the segments of the distributed optical fiber). The larger the deployment density of the distributed optical fiber is, the greater the spatial resolution is, i.e., the higher a detection accuracy of the distributed optical fiber is and the greater the acquisition density of the distributed optical fiber in a spatial dimension. The spatial resolution may also be determined by a laser parameter (e.g., a laser emission intensity and a laser emission interval) of laser emitted from the transmitter of the distributed optical fiber. The greater the laser emission intensity is, the higher the detection accuracy of the distributed optical fiber is. The smaller the laser emission interval is, the higher the acquisition density of the distributed optical fiber is in a temporal dimension. The laser parameter is preset by a technician based on prior experience.

The local strain data refers to data reflecting changes in the accumulated tailings at different geographical locations within the tailings pond. The local strain data is represented by numerical values or the like. A larger numerical value indicates a greater change in the accumulated tailings at the corresponding geographical location. For example, if the local strain data corresponding to a geographical location is 0, it indicates that the accumulated tailings at the geographical location have no strain and no cracks. If the local strain data corresponding to a geographical location changes from 0 to a positive number, it indicates that cracks are developing in the accumulated tailings at the geographical location. If the local strain data corresponding to a geographical location gradually increases, it indicates that a width of the crack in the accumulated tailings at the geographical location is expanding.

In some embodiments, the local strain data at a geographical location may be determined based on variations in the optical signal obtained from the corresponding segment of the distributed optical fiber. For example, the greater the variation in the optical signal obtained by the distributed optical fiber at a geographical location within the tailings pond is, the higher the value of the local strain data corresponding to the geographical location is. Furthermore, the higher the spatial resolution of the distributed optical fiber at a geographical location inside the tailings pond is, the more accurate the result confirmed by the local strain data corresponding to the geographical location is.

In 220, determining a rainfall response capacity of the tailings pond based on water level information obtained by a sensor disposed at the tailings pond.

The water level information refers to information characterizing a depth of water accumulated above the tailings within the tailings pond. For example, the water level information is an average depth measured at a plurality of water level sensor positions. As another example, the water level information is a dataset including water depths at a plurality of water level sensor positions of the tailings pond.

The rainfall response capacity refers to a maximum amount of rainfall per unit time that the tailings pond is able to receive without triggering hazards such as collapse or landslides. The larger the rainfall response capacity is, the safer the tailings pond is.

In some embodiments, the rainfall response capacity is determined in a plurality of ways. For example, the emergency supervision management platform may determine an average of historical rainfall response capacities corresponding to one or more pieces of water level information (also referred to as historical water level records) that match current water level information as the rainfall response capacity for a current water level. The historical water level records corresponding to the current water level information are those, within a statistically defined period, whose difference from the current water level is below a discrepancy threshold. The historical rainfall response capacity corresponding to a historical water level record is determined based on past observations. Illustratively, if a historical water level record shows hazard such as collapse or a landslide occurred at a historical water level at a historical time, the rainfall amount at the historical time is set as the historical rainfall response capacity for the historical water level record.

In 230, determining tailings stability data at a current time point and a future time point, respectively, based on the plurality of local strain data.

The tailings stability data refers to data reflecting a stability level of the tailings. The tailings stability data may be represented by numerical values, or the like. A larger numerical value indicates that the tailings are more stable. For example, a value of 0 represents a maximum stability level, indicating the tailings are most stable. Values less than 0 indicate decreasing stability levels, with smaller values corresponding to lower stability levels.

In some embodiments, the tailings stability data at the current time point is determined based on the plurality of local strain data corresponding to the plurality of geographical locations at the current time point. For example, the tailings stability data at the current time point is a negative value of a ratio of an average of the plurality of local strain data corresponding to the plurality of geographical locations at the current time point to a cumulative detection time.

In some embodiments, the cumulative detection time refers to a total duration from when the distributed optical fiber initiated monitoring until the current time point.

In some embodiments, the tailings stability data at the future time point is determined based on continuous local strain data at a plurality of historical time points within a preset historical period preceding the current time point for each geographical location in the tailings pond. The duration of the preset historical period is predetermined based on prior experience.

The tailings stability data at the future time point may be represented by a strain change rate. The strain change rate refers to a magnitude of change in the local strain data per unit time. By performing statistical analysis on the local strain data within the preset historical period, the magnitude of change in the local strain data per unit time during the historical period is determined as the strain change rate.

In some embodiments, the emergency supervision management platform selects a largest strain change rate from the strain change rates of the plurality of local strain data corresponding to the plurality of geographical locations, and determines a negative value of the largest strain change rate as the tailings stability data at the future time point.

In some embodiments, the emergency supervision management platform determines a negative value of an average strain change rate of the plurality of local strain data corresponding to the plurality of geographical locations as the tailings stability data at the future time point.

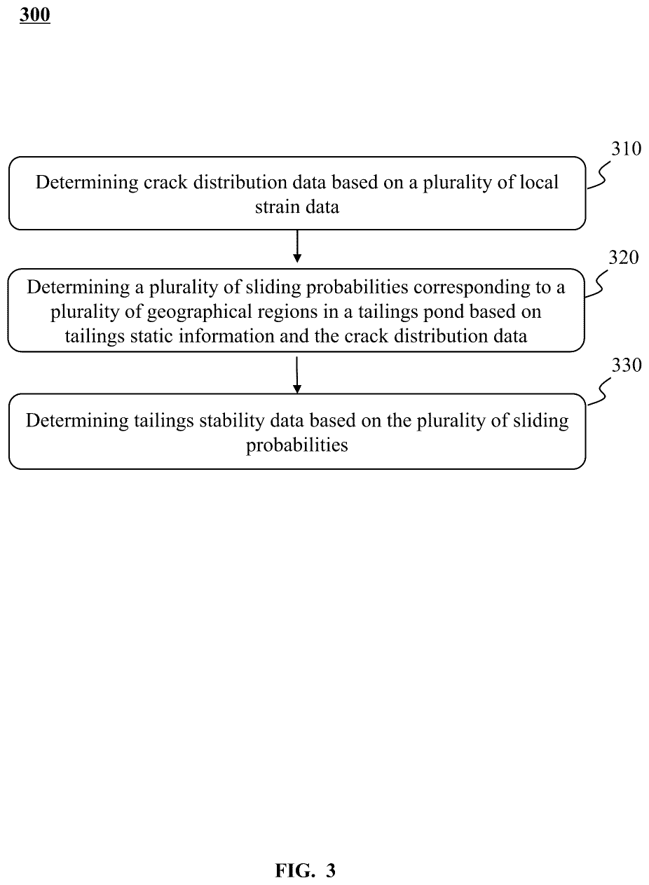

In some embodiments, the emergency supervision management platform may further determine crack distribution data and a plurality of sliding probabilities corresponding to a plurality of geographical regions in the tailings pond, and determine the tailings stability data based on the plurality of sliding probabilities. For more descriptions regarding determining the tailings stability data, please refer to FIG. 3 and its related descriptions.

In 240, determining a target time point and a discharge parameter corresponding to the target time point based on the rainfall response capacity and the tailings stability data.

The target time point refers to a scheduled time for draining water or releasing flood flow from the tailings pond.

In some embodiments, the emergency supervision management platform determines the target time point in a plurality of ways. For example, in response to the rainfall response capacity being less than or equal to a preset rainfall threshold and/or the tailings stability data at the future time point being less than or equal to a preset stability threshold, the emergency supervision management platform determines the current time point as the target time point. As another example, in response to the rainfall response capacity being greater than a user-defined rainfall threshold and the tailings stability data at the future time point being greater than a user-defined stability threshold, the emergency supervision management platform may generate an estimated time required for the rainfall response capacity to reach the user-defined rainfall threshold and an estimated time required for the tailings stability data to reach the user-defined stability threshold based on a difference between the rainfall response capacity and the preset rainfall threshold, a difference between the tailings stability data and the preset stability threshold, a change rate of the rainfall response capacity, and the strain change rate. An average of the estimated times is then taken as a time interval between the target time point and the current time point. The target time point is subsequently calculated based on the time interval.

The change rate of the rainfall response capacity refers to a magnitude of change of the rainfall response capacity per unit time.

In some embodiments, a statistical analysis is performed on the rainfall response capacity within the preset historical period, and the magnitude of change of the rainfall response capacity per unit time within the historical period is determined as the change rate of the rainfall response capacity.

The discharge parameter refers to one or more operating parameters of a drainage facility in the tailings pond. The discharge parameter includes a discharge amount, a discharge rate, or the like. For details regarding the drainage facility, please refer to FIG. 1 and its descriptions.

In some embodiments, the discharge amount includes a count of opened drainage wells, e.g., specifying which drainage wells in the tailings are opened and which drainage wells in the tailings are not opened.

In some embodiments, the discharge rate includes valve opening degrees of different drainage wells. The larger the valve opening degree of a drainage well is, the faster the discharge rate of the drainage well is. An upper limit for the valve opening degree is preset based on prior experience to prevent damage to the drainage well and to avoid tailings collapse or landslide caused by excessively rapid drainage.

In some embodiments, the emergency supervision management platform determines the discharge parameter corresponding to the target time point in a plurality of ways. For example, the emergency supervision management platform determines the discharge parameter by querying a discharge parameter table based on the rainfall response capacity and the tailings stability data.

The discharge parameter table maps different combinations of rainfall response capacities and the tailings stability data to corresponding discharge parameter values.

In some embodiments, the discharge parameter table is constructed based on historical data. For example, the emergency supervision management platform may analyze historical data to determine changes in the rainfall response capacity that occur when different discharge parameter combinations having specific parameter values are applied under different historical rainfall response capacities and tailings stability data. Each discharge parameter combination may include a plurality of discharge parameters, such as a drainage volume and a drainage rate. When application of a discharge parameter combination results in a change in the rainfall response capacity greater than a first preset threshold, a discharge parameter combination having the smallest discharge parameter magnitude among such discharge parameter combinations is determined as a corresponding entry in the discharge parameter table for the corresponding combination of rainfall response capacity and tailings stability data. The first preset threshold may be predetermined based on prior experience.

In some embodiments, the emergency supervision management platform constructs a rainfall vector based on the rainfall response capacity and the tailings stability data; determine at least one rainfall correlation vector corresponding to the rainfall vector by retrieving in a vector database based on the rainfall vector; and determine a target correlation vector and a candidate discharge parameter corresponding to the target correlation vector based on the at least one rainfall correlation vector, and determine the candidate discharge parameter as the discharge parameter.

In some embodiments, the emergency supervision management platform constructs the vector database based on historical data. For example, the emergency supervision management platform may correspondingly store, in historical data, different historical rainfall response capacities and historical tailings stability data in association with discharge parameter combinations applied under the respective historical rainfall response capacities and tailings stability data. Based on the different historical rainfall response capacities and historical tailings stability data in the historical data, candidate rainfall vectors are constructed. For each candidate rainfall vector, discharge parameter combinations that, when applied, result in a change in the rainfall response capacity greater than a second preset threshold are selected as candidate discharge parameters corresponding to the candidate rainfall vector.

The rainfall correlation vector refers to a vector that satisfies a preset vector condition with the rainfall vector. In some embodiments, the preset vector condition includes determining a candidate rainfall vector whose vector distance from the rainfall vector is less than a distance threshold as the rainfall correlation vector. The distance threshold is preset by technical personnel based on prior experience.

In some embodiments, the emergency supervision management platform uses a clustering algorithm or other ways to retrieve and determine at least one rainfall correlation vector corresponding to the rainfall vector from the vector database.

A target correlation vector refers to an optimal rainfall-related vector among the at least one rainfall correlation vector corresponding to the rainfall vector in the vector database.

In some embodiments, the emergency supervision management platform selects a rainfall correlation vector with the smallest vector distance as the target correlation vector, determines the candidate discharge parameter corresponding to the rainfall correlation vector as a candidate discharge parameter for the target correlation vector, and determines the candidate discharge parameter for the target correlation vector as the discharge parameter corresponding to the target time point.

By constructing the rainfall vector that incorporates both the rainfall response capacity and the tailings stability data, the limitations of traditional single-threshold alarms are overcome, providing a comprehensive reflection of the actual safety status of the tailings pond. Simultaneously, the use of the vector database to retrieve the rainfall correlation vector(s) ensures that the recommended discharge parameter is based on historically successful cases rather than theoretical models, significantly reducing the risk of misjudgment.

In some embodiments, based on the discharge parameter determined above, the emergency supervision management platform adjusts the valve opening degree of a drainage well based on water level information at the geographical location of the drainage well. For example, if the water level monitored by a water level sensor at a geographical location is 0, it indicates that there is no accumulated water above the drainage well at the geographical location, and thus there is no need to open the valve. The valve opening degree is adjusted to 0. As another example, if the water level monitored by a water level sensor at a geographical location is h, the emergency supervision management platform determines the valve opening degree of the drainage well based on the calculated discharge rate of the drainage well.

The discharge rate of a drainage well is proportional to a cross-sectional area of a drainage outlet of the drainage well and a water depth inside the well measured from a center of the drainage outlet. In some embodiments, the emergency supervision management platform determines the discharge rate of the drainage well using Equation (1), and further determines the valve opening degree of the drainage well based on a positive correlation between the discharge rate of the drainage well and the valve opening degree.

$$Q = {C}_{d} * A * \sqrt{2 g h} . \qquad ( 1 )$$

In Equation (1), Q denotes the discharge rate of the drainage well. C_{d} denotes a flow coefficient, ranging from 0.6 to 1.0, which is related to a shape and a roughness degree of the drainage outlet and is predetermined in advance. A denotes the cross-sectional area of the drainage outlet of the drainage well, unit in m². g denotes the gravitational acceleration. h denotes the water depth inside the well measured from the center of the drainage outlet, unit in m.

In some embodiments, the emergency supervision management platform further estimates a drainage time required based on the discharge amount of the drainage well and the discharge rate of the drainage well, and closes the valve of the drainage well after drainage is completed.

In 250, controlling a plurality of drainage wells to open drainage valves of the plurality of drainage wells to perform drainage at the target time point based on the discharge parameter.

In some embodiments, the emergency supervision management platform controls a plurality of designated drainage wells to open their drainage valves for drainage at the target time point according to their corresponding valve opening degrees based on the discharge parameter, so as to manage drainage at different geographical locations in the tailings pond.

By integrating multi-source data, distributed optical fiber sensing, and dynamic predictive control, a closed-loop “perception-decision-execution” system for tailings pond safety management is established. This approach enables reasonable determination and control of the discharge amount and the discharge rate for different drainage wells within the tailings pond, thereby minimizing the risks of dam failure and landslides and ensuring the safety of downstream urban residents.

In some embodiments, the emergency supervision management platform further estimates a plurality of predicted response capacities of the tailings pond in a plurality of future periods based on predicted water level information for the plurality of future periods, drainage facility data, and tailings static information, and determines a plurality of predicted discharge parameters for the plurality of future periods based on the plurality of predicted response capacities, the tailings stability data, and predicted rainfall data.

The predicted water level information for a future period refers to estimated water level information corresponding to the future period, for example, the water level information at the future period under the current discharge parameter.

In some embodiments, the predicted water level information is determined based on the water level information at the current time point, the discharge parameter, and the predicted rainfall data.

The drainage facility data refers to relevant information of the drainage facilities, for example, a count of drainage wells, a working status of the drainage wells, etc.

The emergency supervision management platform directly obtains the count of drainage wells in the tailings pond and the working status of the drainage wells through the emergency supervision object platform.

The tailings static information refers to data within tailings-related information that remains relatively unchanged, such as a tailings slope ratio, an initial dam height, an accumulated tailings dam height, a tailings type, a tailings distribution, etc.

In some embodiments, the emergency supervision management platform directly obtains pre-stored data such as the initial tailings dam height, the tailings type, and the tailings distribution to obtain the tailings static information. Alternatively, the emergency supervision management platform acquires data such as the accumulated tailings dam height and the tailings slope ratio by employing measurement technologies on-site at the tailings pond.

The predicted response capacity in a future period refers to a projected maximum rainfall that the tailings pond is predicted to safely withstand during the future period.

In some embodiments, the emergency supervision management platform may determine a reference response capacity by querying a rainfall response capacity table based on the predicted water level information, the drainage facility data, and the tailings static information, and determine the reference response capacity as the predicted response capacity. Each predicted water level information corresponds to one estimated response capacity.

In some embodiments, the rainfall response capacity table contains different sets of actual water level information, drainage facility data, and tailings static information, along with their corresponding reference response capacities. The rainfall response capacity table may be constructed based on historical data. For example, the emergency supervision management platform may analyze historical records to identify instances where an alarm was triggered. For each specific combination of actual water level information, drainage facility data, and tailing static information present at the time of an alarm, the historical rainfall amount that occurred under the combination is identified and set as the reference response capacity for the combination of actual water level information, drainage facility data, and tailing static information. The alarm is triggered when accelerated crack propagation in the tailings is detected, such as when an increase in the local strain data exceeds a predefined amplitude threshold.

The predicted rainfall data for a future period refers to estimated rainfall-related data for the future period, for example, an estimated rainfall amount at the future period, an estimated rainfall time at the future period, or the like.

In some embodiments, the emergency supervision management platform obtains the predicted rainfall data based on data published by a meteorological station.

The predicted discharge parameter for a future period refers to an estimated discharge parameter for the predicted future period. In some embodiments, a plurality of ways is used to determine the predicted discharge parameter. Merely by way of example, the emergency supervision management platform determines the predicted discharge parameter through Step 1 and Step 2 below.

Step 1, in response to a determination that the predicted response capacity does not satisfy a preset condition, the emergency supervision management platform determines an initial predicted discharge parameter through a preset rule. Merely by way of example, the initial predicted discharge parameter is inversely proportional to the tailings stability data and directly proportional to the discharge parameter at a current time point.

In some embodiments, the preset condition includes the predicted response capacity continuously decreasing, a rate of decrease of the predicted response capacity exceeding a magnitude threshold preset based on prior experience, or the like.

The continuous decrease of the predicted response capacity means that the predicted response capacity shows a declining trend over the plurality of future periods.

The rate of decrease of the predicted response capacity refers to a magnitude of decrease of the predicted response capacity per unit time within a given future period. The rate of decrease change of the predicted response capacity in a future period is directly obtained by calculating a magnitude of decrease of the predicted response capacity within the future period and a duration of the future period.

In some embodiments, the emergency supervision management platform determines the initial predicted discharge parameter using Equation (2).

$${P}_{i} = {P}_{c} * ( 1 - D ) . \qquad ( 2 )$$

In Equation (2), Pᵢ denotes the initial predicted discharge parameter, Pc denotes the discharge parameter at the current time point, and D denotes the tailings stability data, which is a negative value.

Step 2, the emergency supervision management platform determines the predicted discharge parameter based on a predicted rainfall amount in the predicted rainfall data and the initial predicted discharge parameter. Merely by way of example, in response to a determination that the predicted rainfall amount is less than the rainfall response capacity, the initial predicted discharge parameter is used as the predicted discharge parameter. As another example, in response to a determination that the predicted rainfall amount is not less than the rainfall response capacity, the predicted discharge parameter is directly proportional to the initial predicted discharge parameter and directly proportional to a ratio of a difference between the predicted rainfall amount and the rainfall response capacity to the rainfall response capacity. Exemplarily, the predicted discharge parameter is calculated using Equation (3).

$${P}_{r} = {P}_{i} * ( 1 + \frac{B - C}{C} ) . \qquad ( 3 )$$

In Equation (3), Pᵣ denotes the predicted discharge parameter, Pᵢ denotes the initial predicted discharge parameter, B denotes the predicted rainfall amount, and C denotes the rainfall response capacity.

In some embodiments, in response to a determination that the predicted response capacity satisfies the preset condition, it is determined that drainage is unnecessary. Alternatively, based on the rainfall response capacity and the tailings stability data, a target time point and a discharge parameter corresponding to the target time point are determined. More description about determining the target time point and the discharge parameter corresponding to the target time point, please refer to FIG. 2.

In some embodiments, the emergency supervision management platform further determines the target time point for the predicted discharge parameter and adjusts a valve opening degree of a drainage well based on a predicted rainfall time in the predicted rainfall data. More descriptions regarding adjusting the valve opening degree of the drainage well, please refer to operation 240 of FIG. 2 above.

In some embodiments, the emergency supervision management platform determines the target time point for the predicted discharge parameter based on the predicted rainfall amount. Merely by way of example, a time interval between the target time point and the predicted rainfall time is determined based on a time interval between the predicted rainfall time and the current time, and a ratio of the predicted rainfall amount to the rainfall response capacity. Exemplarily, the emergency supervision management platform uses Equation (4) to determine the time interval between the target time point and the predicted rainfall time, and then calculates the target time point for the predicted discharge parameter based on the time interval between the target time point and the predicted rainfall time.

$$Δ T = \frac{B}{C} * ( {T}_{f} - {T}_{c} ) . \qquad ( 4 )$$

In Equation (4), ΔT denotes the time interval between the target time point and the predicted rainfall time; T_{f} denotes the predicted rainfall time; T_{c} denotes the current time; B/C denotes the ratio of the predicted rainfall amount to the rainfall response capacity, where the maximum value of B/C is 1.

In some embodiments, the emergency supervision management platform adjusts, at the target time point, valve opening degrees of a plurality of drainage wells based on the predicted discharge parameter.

By integrating the predicted rainfall data, the tailings static information, and the drainage facility data to predict the rainfall response capacities in future periods, it is possible to ensure that the predicted rainfall response capacity conforms to engineering reality. This approach effectively assesses the risk tolerance level of the tailings pond in the future periods, thereby enabling preemptive flood discharge operations before potential disasters such as collapses or landslides occur, ultimately reducing the level of risk.

In some embodiments, the emergency supervision management platform further adjusts the valve opening degrees of a plurality of drainage wells based on change information of the plurality of predicted response capacities.

The change information of the plurality of predicted response capacities is a quantitative indicator describing dynamic characteristics of the predicted response capacity, e.g., a magnitude of change of the predicted response capacity, or the like. The magnitude of change of the predicted response capacity is obtained by calculating a magnitude of change of the predicted response capacity per unit time.

In some embodiments, the emergency supervision management platform designates an absolute value of the magnitude of change of the predicted response capacity as the magnitude of increase required for the valve opening degrees of all drainage wells.

In some embodiments, considering factors such as water evaporation, to ensure the safety of the tailings pond, the rainfall response capacity is expected to gradually increase. In response to the predicted rainfall capacity gradually decreasing, the emergency supervision management platform controls a preset count of drainage wells whose wellhead has a relatively large distance from a water surface, opening their corresponding valves to a maximum opening degree recorded under historically similar water level conditions. The preset count may be set based on prior experience.

Analyzing the magnitude of change of the rainfall response capacity is a crucial manner for assessing the risk tolerance level of the tailings pond. By dynamically analyzing the change information of the predicted response capacities and reasonably regulating the valve opening degrees of the drainage wells based on the change situation of the rainfall response capacities, precise regulation of drainage facilities can be achieved, thereby reducing the risk of disasters in the tailings pond and effectively avoids issues arising from untimely temporary adjustments.

FIG. 3 is a flowchart of an exemplary process for determining tailings stability data according to some embodiments of the present disclosure. Process 300 is performed by the emergency supervision management platform.

Step 310, determining crack distribution data based on a plurality of local strain data.

The crack distribution data refers to statistical information regarding geographical locations of different cracks within the tailings. Merely by way of example, the crack distribution data includes counts of cracks at different geographical locations and corresponding geographical coordinates, etc.

For more description about the local strain data, please refer to FIG. 2.

In some embodiments, in response to the local strain data changing from 0 to a positive value, it indicates that a crack exists at the geographical location. The emergency supervision management platform determines the crack distribution data by statistically analyzing geographical locations where cracks exist.

Step 320, determining a plurality of sliding probabilities corresponding to a plurality of geographical regions in the tailings pond based on tailings static information and the crack distribution data.

For more description about the tailings static information, please refer to FIG. 2.

A geographical region refers to a region obtained by dividing an area where the tailings pond is located. For example, the area where the tailings pond is located is divided horizontally into a plurality of grids at equal intervals, and each grid is a geographical region. As another example, the division is performed based on piezometric sensors, each piezometric sensor serves as a center of a geographical region, and a midpoint of a line connecting two piezometric sensors serves as a boundary point between two geographical regions.

A sliding probability refers to a probability of safety hazards such as collapse, landslide, and crack propagation occurring in the tailings. The sliding probability may be a range value. One geographical region corresponds to one sliding probability.

In some embodiments, the emergency supervision management platform determines the plurality of sliding probabilities for the plurality of geographical regions in various ways based on the tailings static information and the crack distribution data. For example, the emergency supervision management platform retrieves and determines the sliding probability for each geographical region from a sliding vector database. Merely by way of example, the emergency supervision management platform constructs a sliding vector database, stores reference feature vectors in correspondence with reference sliding probabilities, selects at least one sliding-related vector whose distance from a feature vector is less than a distance threshold, and then determines a range value composed of at least one reference sliding probability corresponding to the at least one sliding-related vector as the sliding probability for the geographical region. The feature vector is a vector constructed based on the tailings static information and the crack distribution data.

In some embodiments, the emergency supervision management platform may determine the reference sliding probability based on historical data. Merely by way of example, the emergency supervision management platform may select crack distribution data and tailings static information in the historical data whose difference is less than a preset difference threshold, and determine a percentage of the count of sliding regions corresponding to the selected crack distribution data and tailings static information to the total count of geographical regions as the sliding probability. The preset difference threshold is set based on prior experience. The construction of the sliding vector database is similar to the construction of the vector database. For more details, please refer to FIG. 2 and the related description.

In some embodiments, the emergency supervision management platform determines a predicted phreatic line value of the tailings pond based on the water level information and a plurality of water contents at the plurality of geographical locations, and determines the plurality of sliding probabilities based on the crack distribution data and the predicted phreatic line value.

The water content at a geographical location refers to a ratio of water contained in the soil or tailings materials at the geographical location in the tailings pond.

In some embodiments, the plurality of water contents at the plurality of geographical locations is collected and determined by a plurality of piezometric sensors at the plurality of geographical locations, respectively.

A phreatic line refers to a boundary line between a wet surface and a dry surface formed when water seeps through the tailings.

The predicted phreatic line value refers to data representing distribution information of a plurality of phreatic points of the predicted phreatic line. The geographical location (e.g., three-dimensional coordinates) of a phreatic point may be a range value. The predicted phreatic line value may be represented by a curve (the predicted phreatic line).

In some embodiments, the emergency supervision management platform determines an initial phreatic point based on the water level information. The initial phreatic point refers to a position where the tailings contact a water surface.

In some embodiments, the emergency supervision management platform may set, from the plurality of geographical locations, those whose corresponding water content falls within a preset water content range, as a plurality of phreatic points located within the range of the phreatic line. The preset water content range may be preset based on prior experience. The emergency supervision management platform may perform a fitting process on the plurality of phreatic points to obtain the predicted phreatic line.

In some embodiments, the predicted phreatic line value may be represented by phreatic heights of a plurality of phreatic points. The predicted phreatic line may be formed by connecting the plurality of phreatic points. The phreatic points include a plurality of predicted phreatic points and a plurality of known phreatic points.

In some embodiments, the predicted phreatic line value includes a plurality of predicted phreatic heights of a plurality of predicted phreatic points and a plurality of known phreatic heights of a plurality of known phreatic points. The plurality of predicted phreatic heights are determined based on the plurality of known phreatic points and the plurality of known phreatic heights.

A known phreatic point refers to a phreatic point determined by monitoring through a piezometric sensor. A predicted phreatic point refers to a phreatic point determined by analyzing the known phreatic points.

In some embodiments, the emergency supervision management platform determines the known phreatic height by measuring a height of the known phreatic point through the piezometric sensor. For more description about the piezometric sensor, please refer to FIG. 1.

The predicted phreatic height refers to a height corresponding to the predicted phreatic point.

In some embodiments, the emergency supervision management platform determines the plurality of predicted phreatic heights based on the plurality of known phreatic points and the plurality of known phreatic heights. For example, the emergency supervision management platform may perform a fitting process on the known phreatic heights based on a nonlinear fitting algorithm, etc., to obtain the predicted phreatic heights of the predicted phreatic points. As another example, the emergency supervision management platform may construct a graph structure and determine the predicted phreatic heights of the predicted phreatic points through a phreatic model based on the graph structure.

The graph structure includes nodes and edges. The nodes include known phreatic points and predicted phreatic points. An attribute of a known phreatic point includes the known phreatic height of the known phreatic point. An edge is a connecting line between two adjacent nodes. An attribute of an edge includes a distance and a vertical height difference between the two phreatic points.

In some embodiments, the distance and the vertical height difference between the two phreatic points are measured by the piezometric sensor.

The phreatic model is a model used to determine the predicted phreatic heights through the graph structure. The phreatic model is a machine learning model. For example, the phreatic model may include any one or a combination of a graph neural network model, a large model, or other custom model structures, etc.

In some embodiments, the phreatic model may be obtained by training using a large number of first samples with first labels. In some embodiments, a first sample may include a sample graph structure, and the first label of the first sample may be the predicted phreatic height of a predicted phreatic point corresponding to the first sample. The first samples may be obtained based on historical data, and the first labels may be obtained by manual annotation.

In some embodiments, the emergency supervision management platform may perform training in a plurality of ways based on the first samples and the first labels. For example, training may be performed based on a gradient descent technique. Merely by way of example, a plurality of first samples with first labels are input into an initial phreatic line model, a loss function is constructed based on the first labels and results of the initial phreatic line model, and parameters of the initial phreatic line model are iteratively updated based on the loss function. When the loss function of the initial phreatic line model satisfies an iteration condition, model training is completed, and a trained phreatic line model is obtained. The iteration condition may include convergence of the loss function, a count of iterations reaching a threshold, etc.

By utilizing known phreatic points and known phreatic heights, a predicted phreatic line conforming to reality is determined, which can accurately simulate the actual morphology of the phreatic line in the tailings pond under different working conditions, provide reliable data support for subsequent work, and contributing to improved accuracy in tailings pond safety assessment.

In some embodiments, the emergency supervision management platform obtains crack distribution data and a predicted phreatic line value corresponding to each of a plurality of different geographical regions, respectively. Taking a single geographical region as an example, the emergency supervision management platform, based on the crack distribution data and the predicted phreatic line value of the geographical region, determines a shortest distance between a crack located above the phreatic line and the predicted phreatic line in the geographical region through measurement. A shortest distance of a crack that intersects the phreatic line is 0. The emergency supervision management platform calculates an average value of the shortest distances between a plurality of cracks and the predicted phreatic line in the geographical region, and determines a ratio of the average value to a reference value as the sliding probability for the geographical region. The reference value is determined based on a height range of phreatic points when the water content of the tailings is within a preset range. Exemplarily, the reference value may be a median of the height range of the phreatic points.

In some embodiments, the shortest distance of a crack that intersects the phreatic line is 0. A sliding probability of 1 for an area located below the phreatic line indicates that the tailings below the phreatic line are fully saturated.

The crack distribution data is an effective indicator reflecting whether the tailings pond is at risk. Based on the crack distribution data, the risk of internal collapse of the tailings pond can be reasonably assessed. By determining the predicted phreatic line value based on water level information and water contents at multiple geographical locations, and performing a comprehensive analysis combined with the crack distribution data, the limitations of traditional single-factor assessments are overcome, significantly improving the accuracy of the determined sliding probabilities.

Step 330, determining the tailings stability data based on the plurality of sliding probabilities.

In some embodiments, the emergency supervision management platform determines the tailings stability data based on the plurality of sliding probabilities in a plurality of ways. For example, the emergency supervision management platform determines a negative value of a highest sliding probability as the tailings stability data. As another example, the emergency supervision management platform determines a negative value of an average of maximum values within range values of the plurality of sliding probabilities as the tailings stability data.

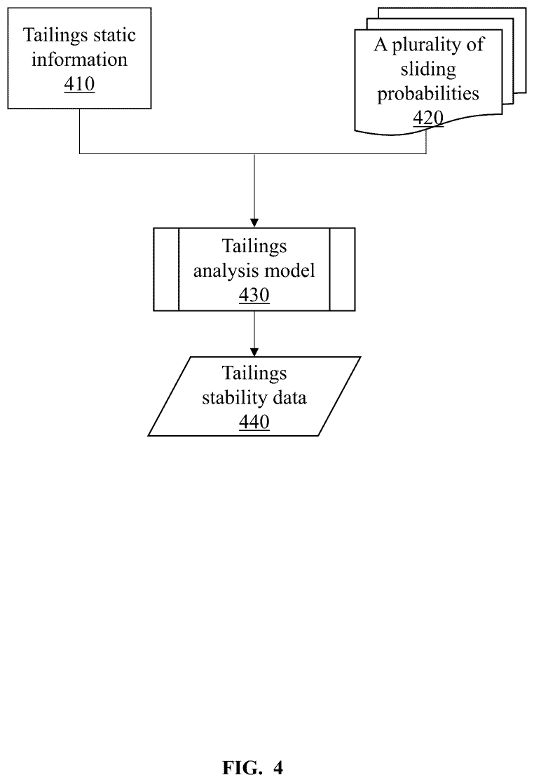

For more description regarding determining the tailings stability data, please refer to FIG. 4.

By comprehensively considering the tailings static information and the crack distribution data, the system 100 effectively improves the accuracy of sliding probability determination, thereby obtaining more accurate tailings stability data, which contributes to early identification of potential risks and provides strong support for the safety management of the tailings pond.

FIG. 4 is an exemplary schematic diagram of a tailings analysis model according to some embodiments of the present disclosure.

In some embodiments, the emergency supervision management platform determines tailings stability data 440 through a tailings analysis model 430 based on tailings static information 410 and a plurality of sliding probabilities 420.

For more description about the sliding probability, please refer to FIG. 3. For the tailings stability data, please refer to FIG. 2.

The tailings analysis model is a model used for analyzing and determining the tailings stability data. The tailings analysis model is a machine learning model. For example, the tailings analysis model includes any one or a combination of a recurrent neural network, a large model, or other custom model structures.

An input of the tailings analysis model includes the tailings static information and the plurality of sliding probabilities. An output of the tailings analysis model includes the tailings stability data.

In some embodiments, the tailings analysis model is obtained by training with a large number of second samples with second labels. Each training sample of the second sample includes a plurality of sample sliding probabilities, sample tailings static information, etc. The second label corresponding to a second sample is sample tailings stability data.

In some embodiments, the second samples are generated based on historical monitoring data. The second label may be determined based on a frequency of alarms issued by an alarm device at a historical time corresponding to the second sample. For example, a higher frequency corresponds to smaller sample tailings stability data.

The training process of the tailings analysis model is similar to that of the phreatic line model. For details, please refer to the related description of the training process of the phreatic line model in FIG. 3.

Determining the tailings stability data through the tailings analysis model allows consideration of the influence of a plurality of factors (such as the tailings static information, the plurality of sliding probabilities, etc.) on the tailings stability data, facilitates the use of the learning capability of the machine learning model to accurately determine the tailings stability data, and thereby enhancing the reliability of risk supervision.

Embodiments of the present disclosure further provide a non-transitory computer-readable storage medium. The storage medium stores computer instructions. When a computer reads the computer instructions in the storage medium, the computer executes the aforementioned method for emergency supervision of a tailings pond.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as “one embodiment,” “an embodiment,” and/or “some embodiments” mean that a certain feature, structure, or characteristic related to at least one embodiment of the present disclosure. Therefore, it is emphasized and noted that the terms “an embodiment,” “one embodiment,” or “an alternative embodiment” mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms “approximately,” “about,” or “substantially.” Unless otherwise specified, “approximately,” “about,” or “substantially” indicates that the stated number allows for a variation of +20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. A system for emergency supervision of a tailings pond based on a large model of Internet of Things (IOT), comprising: an emergency supervision management platform; wherein the emergency supervision management platform is configured to:
determine a plurality of local strain data of the tailings pond based on optical fiber signals obtained from segments of a distributed optical fiber disposed at a plurality of geographical locations of the tailings pond, and a spatial resolution of the distributed optical fiber;
determine a rainfall response capacity of the tailings pond based on water level information obtained by a sensor disposed in the tailings pond;
determine tailings stability data at a current time point and a future time point, respectively, based on the plurality of local strain data;
determine a target time point and a discharge parameter corresponding to the target time point based on the rainfall response capacity and the tailings stability data; and
control a plurality of drainage wells to open drainage valves of the plurality of drainage wells to perform drainage at the target time point based on the discharge parameter.

2. The system according to claim 1, wherein the emergency supervision management platform is further configured to:
construct a rainfall vector based on the rainfall response capacity and the tailings stability data;
determine at least one rainfall correlation vector corresponding to the rainfall vector by retrieving in a vector database based on the rainfall vector; and
determine a target correlation vector and a candidate discharge parameter corresponding to the target correlation vector based on the at least one rainfall correlation vector, and determine the candidate discharge parameter as the discharge parameter.

3. The system according to claim 1, wherein the emergency supervision management platform is further configured to:
determine crack distribution data based on the plurality of local strain data;
determine a plurality of sliding probabilities corresponding to a plurality of geographical regions in the tailings pond based on tailings static information and the crack distribution data; and
determine the tailings stability data based on the plurality of sliding probabilities.

4. The system according to claim 3, wherein the emergency supervision management platform is further configured to:
determine the tailings stability data through a tailings analysis model based on the tailings static information and the plurality of sliding probabilities, wherein the tailings analysis model is a machine learning model.

5. The system according to claim 3, wherein the emergency supervision management platform is further configured to:
determine a predicted phreatic line value of the tailings pond based on the water level information and a plurality of water contents at the plurality of geographical locations; and
determine the plurality of sliding probabilities based on the crack distribution data and the predicted phreatic line value.

6. The system according to claim 5, wherein the predicted phreatic line value includes a plurality of predicted phreatic heights of a plurality of predicted phreatic points and a plurality of known phreatic heights of a plurality of known phreatic points; and the plurality of predicted phreatic heights are determined based on the plurality of known phreatic points and the plurality of known phreatic heights.

7. The system according to claim 1, wherein the emergency supervision management platform is further configured to:
estimate a plurality of predicted response capacities of the tailings pond in a plurality of future periods based on predicted water level information for the plurality of future periods, drainage facility data, and tailings static information;
determine a plurality of predicted discharge parameters for the plurality of future periods based on the plurality of predicted response capacities, the tailings stability data, and predicted rainfall data.

8. The system according to claim 7, wherein the emergency supervision management platform is further configured to:
adjust a valve opening degree of each of the plurality of drainage wells based on change information of the plurality of predicted response capacities.

9. A method for emergency supervision of a tailings pond, implemented by an emergency supervision management platform of a system for emergency supervision of the tailings pond based on a large model of Internet of Things (IOT), the method comprising:
determining a plurality of local strain data of the tailings pond based on optical fiber signals obtained from segments of a distributed optical fiber disposed at a plurality of geographical locations of the tailings pond, and a spatial resolution of the distributed optical fiber;
determining a rainfall response capacity of the tailings pond based on water level information obtained by a sensor disposed in the tailings pond;
determining tailings stability data at a current time point and a future time point, respectively, based on the plurality of local strain data;
determining a target time point and a discharge parameter corresponding to the target time point based on the rainfall response capacity and the tailings stability data; and
controlling a plurality of drainage wells to open drainage valves of the plurality of drainage wells to perform drainage at the target time point based on the discharge parameter.

10. The method according to claim 9, wherein the determining a target time point and a discharge parameter corresponding to the target time point based on the rainfall response capacity and the tailings stability data includes:
constructing a rainfall vector based on the rainfall response capacity and the tailings stability data;
determining at least one rainfall correlation vector corresponding to the rainfall vector by retrieving in a vector database based on the rainfall vector; and
determining a target correlation vector and a candidate discharge parameter corresponding to the target correlation vector based on the at least one rainfall correlation vector, and determining the candidate discharge parameter as the discharge parameter.

11. The method according to claim 9, wherein the determining tailings stability data at a current time point and a future time point, respectively, based on the plurality of local strain data includes:
determining crack distribution data based on the plurality of local strain data;
determining a plurality of sliding probabilities corresponding to a plurality of geographical regions in the tailings pond based on tailings static information and the crack distribution data; and
determining the tailings stability data based on the plurality of sliding probabilities.

12. The method according to claim 11, further comprising:
determining the tailings stability data through a tailings analysis model based on the tailings static information and the plurality of sliding probabilities, wherein the tailings analysis model is a machine learning model.

13. The method according to claim 11, wherein the determining a plurality of sliding probabilities corresponding to a plurality of geographical regions in the tailings pond based on tailings static information and the crack distribution data includes:
determining a predicted phreatic line value of the tailings pond based on the water level information and a plurality of water contents at the plurality of geographical locations; and
determining the plurality of sliding probabilities based on the crack distribution data and the predicted phreatic line value.

14. The method according to claim 13, wherein the predicted phreatic line value includes a plurality of predicted phreatic heights of a plurality of predicted phreatic points and a plurality of known phreatic heights of a plurality of known phreatic points; and the plurality of predicted phreatic heights are determined based on the plurality of known phreatic points and the plurality of known phreatic heights.

15. The method according to claim 9, further comprising:
estimating a plurality of predicted response capacities of the tailings pond in a plurality of future periods based on predicted water level information for the plurality of future periods, drainage facility data, and tailings static information; and
determining a plurality of predicted discharge parameters for the plurality of future periods based on the plurality of predicted response capacities, the tailings stability data, and predicted rainfall data.

16. The method according to claim 15, further comprising:
adjusting a valve opening degree of each of the plurality of drainage wells based on change information of the plurality of predicted response capacities.

17. A non-transitory computer-readable storage medium, storing computer instructions, wherein when a computer reads the computer instructions in the storage medium, the computer executes a method for emergency supervision of a tailings pond, the method comprising:
determining a plurality of local strain data of the tailings pond based on optical fiber signals obtained from segments of a distributed optical fiber disposed at a plurality of geographical locations of the tailings pond, and a spatial resolution of the distributed optical fiber;
determining a rainfall response capacity of the tailings pond based on water level information obtained by a sensor disposed in the tailings pond;
determining tailings stability data at a current time point and a future time point, respectively, based on the plurality of local strain data;
determining a target time point and a discharge parameter corresponding to the target time point based on the rainfall response capacity and the tailings stability data; and
controlling a plurality of drainage wells to open drainage valves of the plurality of drainage wells to perform drainage at the target time point based on the discharge parameter.
